(19) United States
(12) Patent Application Publication
(10) Pub. No.: US 2004/0042624 A1
(43) Pub. Date: Mar. 4, 2004

(54) Method and apparatus for improving automotive audio system performance

(75) Inventors: Mark F. Henderson, Kokomo, IN (US); Steven R. Peelman, Russiaville, IN (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: Delphi Technologies Inc.

(21) Appl. No.: 10/230,767

(22) Filed: Aug. 29, 2002

(51) Int. Cl. H04B 1/00

(52) U.S. Cl. 381/86

(57) ABSTRACT

An adaptive audio system that determines the status of various portal covers such as vehicle doors, windows, sun roofs, hatchbacks, and the like and uses this status information to modify properties of the audio output signal. By adapting the audio output signal of the audio system to the position or status of various vehicle portal covers, the quality and performance of the audio system can be further optimized.

### TECHNICAL FIELD

This invention generally relates to vehicle audio systems and more particularly relates to adaptive vehicle audio systems wherein the status of various vehicle dependent parameters are used to modify properties of the vehicle audio system.

### BACKGROUND OF THE INVENTION

Many advancements have been made in today's vehicle audio systems over systems that were available as recently as twenty years ago. The improvement in vehicle audio systems has been so dramatic in the last twenty years that they perform at levels that easily rival all but the most expensive home entertainment systems. This accomplishment is significant especially when one considers the noisy environment in which an automotive audio system must operate. For example, many of the environmental factors which can detract from a listener's enjoyment (and which are easily controlled in a home listening environment), are largely uncontrollable in an automotive audio system. Such factors as traffic noise, road noise, engine noise, and the like are noise factors which can in some cases be reduced, but might be difficult to compensate for completely.

One known technique for minimizing engine related noise can be found in U.S. Pat. No. 5,524,0547, entitled Noise-Canceling Apparatus. This invention focuses on the noise generated by the vehicle engine and characterizes various attributes of engine noise (frequency, power level, and the like). From these various attributes, a noise-canceling signal is produced which is output to the vehicle audio speakers. The net result is that (at least at select noise-canceling points within the vehicle), various noises can be canceled (or at least greatly attenuated) within the vehicle passenger compartment.

In addition to the sophisticated approach mentioned above, other less sophisticated systems are also used in an attempt to enhance the audio listening experience of the vehicle passenger. Such systems include increasing the volume of the audio system as the vehicle speed increases. The logic behind this approach is that it is generally known that road noise increases as a function of vehicle speed. Accordingly, as a vehicle travels faster and faster, it seems logical that a certain amount of vehicle road noise can be “drowned out” by simply increasing the volume of the audio program being delivered by the vehicle audio system.

Another approach for enhancing the audio listening enjoyment of vehicle passengers is set forth in U.S. Pat. No. 6,169,807 wherein an audio level control device is used for adjusting the audio output level of a vehicle audio system as a function of the changes in ambient sound levels detected within the passenger compartment.

While each of these various methods may effectively enhance the audio listening enjoyment of the vehicle passengers, none of them directly address the change in audio environment that arises when one or more of the vehicle windows is lowered, a sunroof is open or one or more of the vehicle doors is ajar. The present invention incorporates portal status information and uses such information to alter one or more properties of the audio output signal. Portal status information may be obtained from window status sensors, sunroof status sensors and/or door status sensors for respectively sensing the position of the vehicle windows, sunroof and/or the vehicle doors and uses this status information for adjusting one or more properties of the audio output signal thereby compensating for degradations which would otherwise occur in the quality of the listening experience enjoyed by vehicle passengers. The present invention may also utilize derived portal position status information for window, sunroof, and/or door, as may be available from a data bus interface which uses electronic pulses of a particular type to control position of the window, sunroof and/or doors or to provide status information from automotive windows, sunroofs and/or doors. This derived portal position status information may be utilized for adjusting one or more properties of the audio output signal.

### BRIEF DESCRIPTION OF THE DRAWINGS

FIG. 1 is a block diagram of the adaptive audio system of the present invention.

### DETAILED DESCRIPTION OF THE PREFERRED EMBODIMENTS

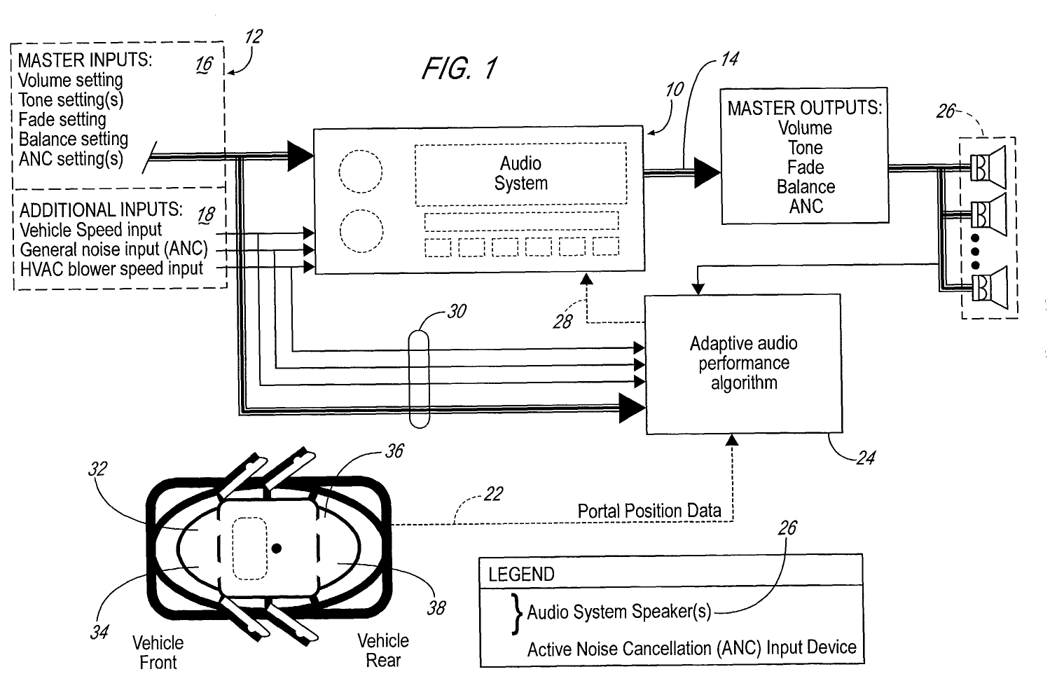

Now referring to FIG. 1, audio system 10 contains amplifiers (including pre amplifiers and power amplifiers), AM/FM tuner, CD mechanism, cassette player mechanism, and the like. Various input controls 12 are used to generate various input commands used by audio system 10 to modify its output signal 14. Input controls 12 are grouped into two distinct classes: master inputs and additional inputs. Master inputs 16 are those inputs which are typically made accessible to the vehicle operator so that the vehicle operator can easily adjust audio system 10 to his listening preferences. Such master inputs typically include volume, tone, fade, balance, and/or active noise cancellation (ANC) settings. Additional inputs 18 are input signals which are acted upon by audio system 10 to control one or more features of output signal 14; however, additional inputs 18 are not directly set by the vehicle operator but rather are automatically set in response to one or more vehicle environmental conditions. Typical additional inputs include vehicle speed, general ambient noise as detected by the active noise cancellation input device and HVAC blower speed input signal.

The present invention incorporates portal status information 22 to adapt the audio performance of a vehicle audio system. A portal is any portion of the vehicle capable of creating a variable opening between the passenger compartment and the environment surrounding the exterior of the vehicle. Portals may include, for example, windows, doors, sun roofs, retractable/removable tops, rear hatches, etc. Portal status information 22 can be directly derived from portal position sensors such as window sensors which generate window position data or door position sensors which generate door position data. Alternatively, portal status information can be indirectly derived. For example, many vehicle windows, doors, sunroofs, etc., are positioned using motorized controls which implement analog, pulsed, other electrical signals to control an electric motor. The approximate position of a portal covering can be indirectly derived by keeping track of the time duration, pulse count, amplitude, or other signal attributes.

By incorporating portal status 22 into adaptive audio performance algorithm 24, a noticeable improvement in audio system performance is achieved. The primary reason that the audio system of the present invention offers distinct improvements over typical prior art systems is that it compensates for changes in vehicle interior dynamics which can drastically detract from the audio quality of the listener's enjoyment of vehicle audio system. Tone, volume, balance, and other attributes of output signal 14 as reproduced by audio system speakers 26, are drastically affected by portals in the vehicle passenger compartment. Any vehicle audio system that does not take into consideration window position, door position, sunroof position, rear hatch position, and the like cannot achieve its optimum performance because if these portal conditions are left unaccounted for, they will drastically alter the acoustical environment in which the audio system is designed to operate under.

The present system can be implemented in any number of ways. Some possible implementations are set forth below.

First Embodiments

Adaptive audio performance algorithm 24 is designed to monitor the portal position data 22 and to command audio system 10 (via output command line 28) to adjust the overall volume, tone, fade, and/or balance of output signal 14 if a portal is open at least a predetermined percent. This predetermined percentage may be the same for all portals found on the vehicle or this percentage may be individually determined for each vehicle portal.

Second Embodiments

In the second embodiment the adaptive audio performance algorithm 24 is used to monitor one or more portal positions by way of portal communication link 22. In this embodiment, only the speaker closest to an open portal is adjusted in an attempt to overcome the additional noise created by the open portal. For example, if the passenger front door window is open one half way, the speaker located within or near the passenger front door could modify the volume tone, etc. in order to help overcome the noise generated from the open portal. Likewise, if both front windows are lowered, the power, tone, etc. to the two front speakers 32, 34 would be adjusted as a function of the degree to which the windows are opened.

In either of the two above embodiments, the adaptive audio performance algorithm can act linearly solely on the input information provided to it on communication link 22 and issue the appropriate command signal to audio system 10 along output command line 28. However, the performance algorithm can operate in a more sophisticated manner. Specifically, in addition to using to the input information provided by way of communication link 22, algorithm 24 can also use the master input information 16 and the additional input information 18 provided along bus 30. It can then combine all of these inputs 20, 22, 30 and offer a much more sophisticated control algorithm than it would otherwise be able to if it were simply acting on less than all of this information. For example, it is possible to incorporate the active noise cancellation algorithm within the adaptive audio performance algorithm of the present invention. By incorporating both of these methods into the same algorithm 24, it is very easy to, for example, disable the ANC function if the doors are open. Or, it may be desirable to enable the ANC function if one or more of the portals are opened at least a predetermined percent.

The portal status sensors can be comprised of any number of devices known for detecting position through a continuous range including potentiometers, capacitive sensing devices, inductive sensing devices, optical sensing devices, acoustic sensing device and the like. It is also contemplated that very simple sensing devices may be used such as binary switches which may operate to indicate when a portal is open but not necessarily provide information regarding the degree to which is open. Likewise, in a most simplistic approach, the portal status sensors may simply be switches which are only capable of detecting one of two possible modes (e.g. open half way or greater/not open half way or greater). If such crude binary sensors are used, it is contemplated that the system will not perform as well as it would by using sensors capable of much greater resolution. However, in some applications the use of low resolution sensors may render satisfactory results.

In addition, the absolute or relative position of a portal may be indirectly inferred by monitoring one or more characteristics of the electrical signal used to drive the motor connected to a portal cover. This could involve monitoring voltage or current for straight D.C. motor applications, and could also include monitoring pulse count or pulse width for pulse control applications. The absolute or relative position of a portal cover may also be obtainable by other derived means or methods, and the status thereof communicated by any means standardized for automotive use.

The present invention contemplates communication of portal position data 22 to take place using any number of well known communication techniques including, dedicated wires, digital bus transmission techniques, optical communication techniques, radio telemetry or the like.

The foregoing detailed description shows that the preferred embodiments of the present invention are well suited to fulfill the object of the invention. It is recognized, however, that those skilled in the art may make various modifications or additions to the preferred embodiments chosen here to illustrate the present invention, without departing from the spirit of the present invention. Accordingly, it is to be understood that the coverage sought to be afforded hereby should be deemed to extend to the subject matter defined in the appended claims, including all fair equivalents thereof.

What is claimed is:

1. An adaptive audio system for use in a vehicle having at least one portal and one corresponding portal cover comprising:
an audio system for generating an audio output signal;
at least one portal cover position determining device for generating a portal status signal;
an adaptive audio circuit coupled to said portal status signal and to said audio system;
wherein said adaptive audio circuit uses the status information contained in said portal to modify a property of said audio output signal.

2. The adaptive audio system of claim 1, wherein said modified property includes at least one of a volume, tone, fade, balance, or ANC.

3. The adaptive audio system of claim 1, wherein said adaptive audio circuit is further coupled to at least one of a vehicle speed input, an ANC input or an HVAC input.

4. The adaptive audio system of claim 1, wherein said portal cover position determining device includes at least one of a capacitive, resistive, inductive, optical, acoustic or binary switching sensing devices.

5. The adaptive audio system of claim 1, wherein portal cover position determining device includes a motor for controlling the movement of the portal cover and a circuit for monitoring a control signal sent to said motor, wherein said circuit indirectly determines the position of the portal cover.

6. The adaptive audio system of claim 1, wherein said coupling circuit includes at least dedicated wires, digital bus transmission, optical communication, or radio telemetry.

7. A method of adapting the audio performance of a audio system used in a vehicle having at least one portal and one corresponding portal cover, comprising the steps of:
A) determining a position of said portal cover,
B) converting said portal position into a position signal and transmitting said signal to an adaptive audio performance module,
C) modifying a property of an output signal of said audio system, based on said portal position signal.

8. The method of claim 7, wherein step C), includes modifying at least one of a volume, tone, fade, balance, or ANC property of said output signal of said audio system.

9. The method of claim 7, wherein step A) includes sensing the degree to which said portal cover is open, and wherein step C) includes modifying said property as a function of the degree to which said portal cover is open.

10. The method of claim 7, further including the step of:
D) associating at least one speaker with said at least one portal,
E) coupling said output signal of said audio system to said at least one speaker,
F) modifying said output signal to said at least one speaker of step E) as a function of the determined position of a portal cover associated with the speaker of step E).

11. The method of claim 7, wherein step A) further includes directly determining the position of said portal cover by way of a portal cover position sensor.

12. The method of claim 7, wherein step A) includes indirectly determining the position of said portal cover by way of monitoring a command signal coupled to a motor connected to said portal cover.

13. The method of claim 7, further including the step of D) modifying a property of an output signal of said audio system, based on an interaction between said at least one portal cover and a vehicle speed input, a general noise input, or an HVAC blower speed input.
